(19) United States
(12) Patent Application Publication
(10) Pub. No.: US 2024/0267978 A1
(43) Pub. Date: Aug. 8, 2024

(54) ENHANCED BEAM MANAGEMENT IN CELLULAR COMMUNICATION NETWORKS

(71) Applicant: Nokia Technologies Oy, Espoo (FI)

(72) Inventors: Samantha CAPORAL DEL BARRIO, Aalborg (DK); Sami-Jukka HAKOLA, Oulu (FI); Mihai ENESCU, Espoo (FI)

(21) Appl. No.: 18/569,574

(22) PCT Filed: May 19, 2022
(86) PCT No.: PCT/EP2022/063548

§ 371 Date: Dec. 12, 2023

(30) Foreign Application Priority Data
Jun. 14, 2021 (FI) 20215691

(51) Int. Cl. H04W 76/20; H04L 5/00; H04W 16/28

(52) U.S. Cl. CPC H04W 76/20; H04L 5/0053; H04W 16/28

(57) ABSTRACT

According to an example aspect of the present invention, there is provided an apparatus comprising means for receiving from a wireless network node association information between a set of activated Transmission Coordination Indication, TCI, states and a set of Uplink, UL, indication signals, wherein at least one activated TCI state of the set of activated TCI states is associated with at least one UL indication signal of the set of UL indication signals, means for communicating with the wireless network node using a first activated TCI state of the set of activated TCI states and means for transmitting one UL indication signal of the set of UL indication signals to the wireless network node, wherein said one UL indication signal indicates a second activated TCI state of the set of activated TCI states.

### FIELD

Various example embodiments relate in general to cellular communication networks and more specifically, to beam management in such networks.

### BACKGROUND

Beam management may refer to a set of functionalities that can be used to enhance operation of beam-based wireless communication systems. Beam management may be used for example in various cellular communication networks, such as, in cellular communication networks operating according to 5G radio access technology. 5G radio access technology may also be referred to as New Radio, NR, access technology. 3rd Generation Partnership Project, 3GPP, develops standards for 5G/NR and one of the topics in the 3GPP discussions is related to beam management. According to the discussions there is a need to provide enhanced methods, apparatuses and computer programs related to beam management in cellular communication networks. Such enhancements may also be beneficial in other wireless communication networks as well.

### SUMMARY

According to some aspects, there is provided the subject-matter of the independent claims. Some example embodiments are defined in the dependent claims.

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to a first aspect of the present invention, there is provided an apparatus comprising means for receiving from a wireless network node association information between a set of activated Transmission Coordination Indication, TCI, states and a set of Uplink, UL, indication signals, wherein at least one activated TCI state of the set of activated TCI states is associated with at least one UL indication signal of the set of UL indication signals, means for communicating with the wireless network node using a first activated TCI state of the set of activated TCI states and means for transmitting one UL indication signal of the set of UL indication signals to the wireless network node, wherein said one UL indication signal indicates a second activated TCI state of the set of activated TCI states. The apparatus of the first aspect may be a user equipment or a control device configured to control the functioning thereof, possibly when installed therein.

Example embodiments of the first aspect may comprise at least one feature from the following bulleted list or any combination of the following features:
each UL indication signal of the set of UL indication signals indicates a separate activated TCI state of the set of activated TCI states;
the apparatus further comprises means for detecting a need to change from the used, first activated TCI state of the set of activated TCI states to the second activated TCI state of the set of activated TCI states;
the apparatus further comprises means for receiving an acknowledgement from the wireless network node, wherein the acknowledgement indicates that the second activated TCI state of the set activated TCI states is to be used and means for communicating with the wireless network node using the second activated TCI state of the set of activated TCI states upon receiving the acknowledgement;
the apparatus further comprises means for receiving an acknowledgement from the wireless network node, wherein the acknowledgement indicates that a third activated TCI state of the set of activated TCI states is to be used and means for communicating with the wireless network node using the third activated TCI state of the set of activated TCI states upon receiving the acknowledgement;
the apparatus further comprises means for receiving an acknowledgement from the wireless network node, wherein the acknowledgement is a negative acknowledgement and means for communicating with the wireless network node using a fall-back TCI state upon receiving the negative acknowledgement;
the apparatus further comprises means for starting a beam activation timer upon receiving an acknowledgement from the wireless network node and means for communicating with the wireless network node using the second activated TCI state, a third activated TCI state or a fall-back TCI state upon expiry of the beam activation timer;
the apparatus further comprises means for starting an acknowledgement timer upon transmitting said one UL indication signal and means for communicating with the wireless network node using a fall-back TCI state when no acknowledgement was received while the acknowledgement timer was running;
the apparatus further comprises means for communicating with the wireless network node using the second activated TCI state without waiting for any acknowledgement;
the apparatus further comprises means for starting a beam switch delay timer upon transmitting said one UL indication signal and means for communicating with the wireless network node using the second activated TCI state upon expiry of the beam switch delay timer;
the apparatus further comprises means for transmitting at least one other UL indication signal of the set of UL indication signals to the wireless network node, means for receiving an indication from the wireless network node, wherein the indication indicates an activated TCI state to be used, the activated TCI state to be used being the second activated TCI state corresponding to said one UL indication signal or an activated TCI state corresponding to the at least one other UL indication signal and means for communicating with the wireless network node using the activated TCI state to be used;
said one UL indication signal and the at least one other UL indication signal are transmitted within a preamble transmission time window.

According to a second aspect of the present invention, there is provided an apparatus comprising means for transmitting to a user equipment association information between a set of activated Transmission Coordination Indication, TCI, states and a set of UL indication signals, wherein at least one activated TCI state of the set of activated TCI states is associated with at least one Uplink, UL, indication signal of the set of UL indication signals, means for communicating with the user equipment using a first activated TCI state of the set of activated TCI states and means for receiving from the user equipment one UL indication signal of the set of UL indication signals, wherein said one UL indication signal indicates a second activated TCI state of the set of activated TCI states. The apparatus of the second aspect may be a wireless network node or a control device configured to control the functioning thereof, possibly when installed therein.

According to a third aspect, there is provided a first method comprising, receiving from a wireless network node association information between a set of activated Transmission Coordination Indication, TCI, states and a set of Uplink, UL, indication signals, wherein at least one activated TCI state of the set of activated TCI states is associated with at least one UL indication signal of the set of UL indication signals, communicating with the wireless network node using a first activated TCI state of the set of activated TCI states and transmitting one UL indication signal of the set of UL indication signals to the wireless network node, wherein said one UL indication signal indicates a second activated TCI state of the set of activated TCI states. The first method may be performed by a user equipment or a control device configured to control the functioning thereof, possibly when installed therein.

According to a fourth aspect, there is provided a second method comprising, transmitting to a user equipment association information between a set of activated Transmission Coordination Indication, TCI, states and a set of UL indication signals, wherein at least one activated TCI state of the set of activated TCI states is associated with at least one Uplink, UL, indication signal of the set of UL indication signals, communicating with the user equipment using a first activated TCI state of the set of activated TCI states and receiving from the user equipment one UL indication signal of the set of UL indication signals, wherein said one UL indication signal indicates a second activated TCI state of the set of activated TCI states. The second method may be performed by a wireless network node or a control device configured to control the functioning thereof, possibly when installed therein.

According to a fifth aspect of the present invention, there is provided an apparatus comprising at least one processing core, at least one memory including computer program code, the at least one memory and the computer program code being configured to, with the at least one processing core, cause the apparatus at least to receive from a wireless network node association information between a set of activated Transmission Coordination Indication, TCI, states and a set of Uplink, UL, indication signals, wherein at least one activated TCI state of the set of activated TCI states is associated with at least one UL indication signal of the set of UL indication signals, communicate with the wireless network node using a first activated TCI state of the set of activated TCI states and transmit one UL indication signal of the set of UL indication signals to the wireless network node, wherein said one UL indication signal indicates a second activated TCI state of the set of activated TCI states. The apparatus of the fifth aspect may be a user equipment or a control device configured to control the functioning thereof, possibly when installed therein.

According to a sixth aspect of the present invention, there is provided an apparatus comprising at least one processing core, at least one memory including computer program code, the at least one memory and the computer program code being configured to, with the at least one processing core, cause the apparatus at least to transmit to a user equipment association information between a set of activated Transmission Coordination Indication, TCI, states and a set of UL indication signals, wherein at least one activated TCI state of the set of activated TCI states is associated with at least one Uplink, UL, indication signal of the set of UL indication signals, communicate with the user equipment using a first activated TCI state of the set of activated TCI states and receive from the user equipment one UL indication signal of the set of UL indication signals, wherein said one UL indication signal indicates a second activated TCI state of the set of activated TCI states. The apparatus of the second aspect may be a wireless network node or a control device configured to control the functioning thereof, possibly when installed therein.

According to a seventh aspect of the present invention, there is provided a non-transitory computer readable medium having stored thereon a set of computer readable instructions that, when executed by at least one processor, cause an apparatus to at least to perform the first method. According to an eighth aspect of the present invention, there is provided a non-transitory computer readable medium having stored thereon a set of computer readable instructions that, when executed by at least one processor, cause an apparatus to at least to perform the second method.

According to a ninth aspect of the present invention, there is provided a computer program comprising instructions which, when the program is executed by an apparatus, cause the apparatus to carry out the first method. According to a tenth aspect of the present invention, there is provided a computer program comprising instructions which, when the program is executed by an apparatus, cause the apparatus to carry out the second method.

### BRIEF DESCRIPTION OF THE DRAWINGS

FIG. 1 illustrates an example of a network scenario in accordance with at least some example embodiments;

FIG. 2 illustrates a first signaling graph in accordance with at least some example embodiments;

FIG. 3 illustrates a second signaling graph in accordance with at least some example embodiments;

FIG. 4 illustrates an example apparatus capable of supporting at least some example embodiments;

FIG. 5 illustrates a flow graph of a first method in accordance with at least some example embodiments;

FIG. 6 illustrates a flow graph of a second method in accordance with at least some example embodiments.

### EXAMPLE EMBODIMENTS

Beam management may be enhanced by the procedures described herein. More specifically, beam management may be enhanced by associating at least some activated Transmission Coordination Indication, TCI, states of a User Equipment, UE, with Uplink, UL, indication signals, such as Contention-Free Random Access, CFRA, preambles. Each UL indication signal may be associated with a separate, different activated TCI state. Thus, the UE may indicate an activated TCI state preferred by the UE by transmitting to a wireless network node a certain UL indication signal that corresponds to the preferred activated TCI state. The UE may transmit the UL indication signal after detecting that UL conditions have been degraded. Thus, the activated TCI state may be changed even if the wireless network node would not be aware of degradation of UL conditions. The wireless network node may still remain in charge of the operation, because the wireless network node may decide to use some other activated TCI state of the UE or a fall-back TCI state may be used.

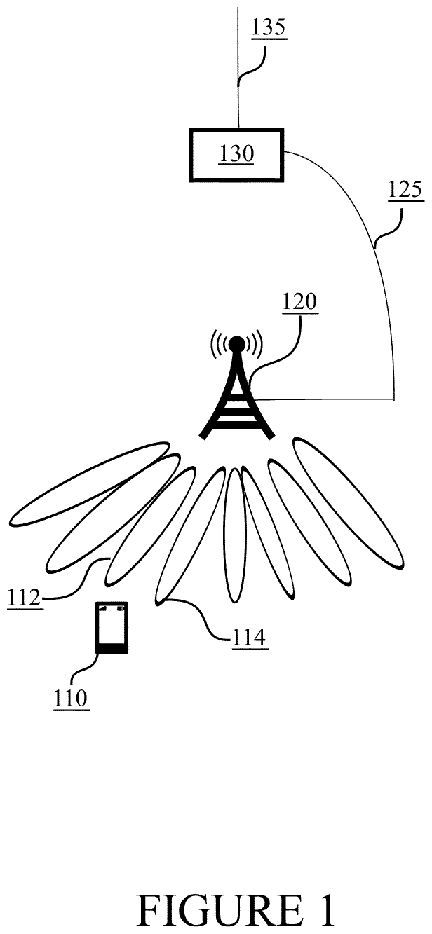

FIG. 1 illustrates an example of a network scenario in accordance with at least some example embodiments. According to the example scenario of FIG. 1, there may be a beam-based wireless communication system, which comprises UE 110, wireless network node 120 and core network element 130. UE 110 may be connected to wireless network node 120 via air interface using beams 112 and 114, either simultaneously or one at a time.

UE 110 may comprise, for example, a smartphone, a cellular phone, a Machine-to-Machine, M2M, node, Machine-Type Communications, MTC, node, an Internet of Things, IoT, node, a car telemetry unit, a laptop computer, a tablet computer or, indeed, any kind of suitable wireless terminal. In the example system of FIG. 1, UE 110 may communicate wirelessly with wireless network node 120 via beam 112 and/or beam 114. Wireless network node 120 may be considered as a serving node for UE 110 and one cell of wireless network node 120 may be a serving cell for UE 110.

Air interface between UE 110 and wireless network node 120 may be configured in accordance with a Radio Access Technology, RAT, which both UE 110 and wireless network node 120 are configured to support. Examples of cellular RATs include Long Term Evolution, LTE, New Radio, NR, which may also be known as fifth generation, 5G, radio access technology and MulteFire.

For example in the context of LTE, wireless network node 120 may be referred to as eNB while wireless network node 120 may be referred to as gNB in the context of NR. In some example embodiments, wireless network node 120 may be referred to as a Transmission and Reception Point, TRP, or control multiple TRPs that may be co-located or non-co-located. In any case, example embodiments of the present invention are not restricted to any particular wireless technology. Instead, example embodiments may be exploited in any beam-based wireless communication system, wherein beam management would be beneficial.

Wireless network node 120 may be connected, directly or via at least one intermediate node, with core network 130 via interface 125. Core network 130 may be, in turn, coupled via interface 135 with another network (not shown in FIG. 1), via which connectivity to further networks may be obtained, for example via a worldwide interconnection network. Wireless network node 120 may be connected, directly or via at least one intermediate node, with core network 130 or with another core network.

In some example embodiments, the network scenario may comprise a relay node instead of, or in addition to, UE 110 and/or wireless network node 120. Relaying may be used for example when operating on millimeter-wave frequencies. One example of the relay node may be an Integrated Access and Backhaul, IAB, node. The IAB node may be referred to as a self-backhauling relay as well. Another example of a relay may be an out-band relay. In general, the relay node may comprise two parts:
1) Distributed Unit, DU, part which may facilitate functionalities of wireless network node 120, such as a gNB. Thus, in some example embodiments, the DU part of a relay may be referred to as wireless network node 120 and the DU may perform tasks of wireless network node 120;
2) Mobile Termination, MT, part which may facilitate functionalities of UE 110, i.e., a backhaul link which may be the communication link between a parent node (DU), such as a DU part of wireless network node 120, and the relay, such as an IAB node. In some example embodiments, the MT part may be referred to as UE 110 and perform tasks of UE 110.

Example embodiments of the present invention provide enhancements at least for UL beam management, and possibly for joint UL and Downlink, DL, management. Example embodiments of the present invention provide enhancements by proposing means for facilitating at least UL beam pair link selection initiated by UE 110.

Beam management may for example comprise a set of L1/L2 procedures and signaling between UE 110 and wireless network node 120 to keep transmit and receive beams of UE 110 and wireless network node 120 aligned during the connection, i.e., while UE 110 is in connected mode. More specifically, beam management may define a set of functionalities to assist UE to set its receive and transmit beams for downlink receptions and UL transmissions, respectively. The functionalities may be, e.g., categorized according to the following four groups:
1. Beam Indication: Assist UE 110 to set its receive and transmit beams properly for the reception of DL signals and transmission of UL signals, respectively;
2. Beam Acquisition, Measurements and Reporting: Procedures for providing wireless network node 120 knowledge about feasible DL and UL beams for UE 110;
3. Beam Recovery: For rapid link reconfiguration against sudden blockages, i.e. fast re-alignment of beams of UE 110 and wireless network node 120;
4. Beam Tracking and Refinement: Set of procedures to refine beams of UE 110 and wireless network node 120.

As an example, regarding DL beam management and especially for Beam Acquisition, Measurements and Reporting, the following beam management procedures may be supported within one or multiple TRPs of the serving cell:
1. P-1 may be used to enable measurements of UE 110 on different transmit beams of a TRP to support selection of transmit beam(s) of the TRP and/or receive beam(s) of UE 110. For beamforming at the TRP, an intra/inter-TRP transmit beam sweep from a set of different beams may be used. For beamforming at UE 110, a receive beam sweep of UE 110 from a set of different beams may be used;
2. P-2 may be used to enable measurements of UE 110 on different transmit beams of the TRP to possibly change inter/intra-TRP Tx beam(s), possibly from a smaller set of beams for beam refinement than in P-1. P-2 may be a special case of P-1;
3. P-3 may be used to enable measurements of UE 110 on the same transmit beams of the TRP to change receive beam of UE 110 when UE 110 uses beamforming.

Beam management may be particularly useful at higher carrier frequencies (such as above 6 GHz), because UEs operating on such frequencies are typically equipped with one or multiple antenna arrays or antenna modules per digital input and both transmission and reception beam pattern per digital input are more narrow than omni-directional beam pattern typically used at below 6 GHz. Nevertheless, example embodiments of the present invention may be applied in any beam-based wireless communication system, regardless of the used carrier frequency.

Quasi Co-Location, QCL, indication functionality may be exploited for beam management. Two antenna ports may be considered as QCL'ed if properties of a channel over which a symbol is transmitted via a first antenna port can be derived from channel over which a symbol is transmitted via a second antenna port. Regarding downlink beam indication, QCL indication functionality may be defined as follows. The principle to receive a certain physical signal or physical channel may be that UE 110 is either configured with, or UE 110 implicitly determines, a source/reference Reference Signal, RS, that UE 110 has received and measured earlier which defines how to set a receive beam of UE 110 for the reception of the downlink (target) physical signal or channel to be received. To provide UE 110 with QCL characteristics for the target signal (to be received) a TCI framework may be used.

According to the TCI framework, UE 110 may be configured with TCI state(s) to provide UE 110 with source RS(s) for determining QCL characteristics. Each TCI state may include for example one or two source RSs that provide QCL TypeA, TypeB, TypeC and/or TypeD parameters to UE 110, e.g., as follows:
QCL-TypeA: {Doppler shift, Doppler spread, average delay, delay spread}
QCL-TypeB: {Doppler shift, Doppler spread}
QCL-TypeC: {Doppler shift, average delay}
QCL-TypeD: {Spatial Rx parameter}

In UL, a parameter called spatial relation info may be provided to UE 110, the parameter providing a spatial source RS based on which UE 110 may determine the UL transmit beam. The spatial source RS may be a DL RS, such as a Synchronization Signal Block, SSB, or Channel State Information-RS, CSI-RS or UL RS, like a Sounding Reference Signal, SRS. For each Physical UL Control Channel, PUCCH, and SRS resource, wireless network node 120 may provide explicitly the spatial source while for UL an indirect indication may be provided. For instance, the spatial source may be provided for Physical UL Shared Channel, PUSCH as follows:
PUSCH may be scheduled using Downlink Control Information, DCI, format 0_0, and the spatial source may be the same as with a certain PUCCH resource;
PUSCH may be scheduled using DCI format 0_1, and the spatial source may be the same as indicated SRS resource(s). One SRS resource may be indicated in a codebook based transmission scheme. Alternatively, one or multiple SRS resources may be indicated in non-codebook based transmission scheme.

In some example embodiments, a default spatial relation may be used for dedicated PUCCH/SRS (except SRS with usage=‘beamManagement’ and SRS with usage=‘nonCodeBook’ and configured with associated CSI-RS). If spatial relation is not configured, e.g., in Frequency Range 2, FR2, UE 110 may determine the spatial source as follows:
If Control Resource Set(s), CORESET(s) are configured on a Component Carrier, CC, the TCI state/QCL assumption of the CORESET may be the TCI state with the lowest Identity, ID; or
If any CORESET(s) are not configured on the CC, the activated TCI state with the lowest ID applicable to a Physical Downlink Shared Channel, PDSCH, in the active DL Bandwidth Part, BWP of the CC, may be the TCI state/QCL assumption.

Furthermore, a default spatial relation for PUSCH may be scheduled by DCI format 0_0 and UE 110 may determine the spatial relation as follows:
If there are no PUCCH resources configured on the active UL BWP CC, the default spatial relation may be the TCI state/QCL assumption of the CORESET with the lowest ID. The default pathloss RS may be the QCL-TypeD RS of the same TCI state/QCL assumption of the CORESET with the lowest ID;
If there are no PUCCH resources configured on the active UL BWP CC in FR2 and UE 110 is in RRC-connected mode, the default spatial relation may be the TCI state/QCL assumption of the CORESET with the lowest ID.

In some example embodiments, the default pathloss RS may be the QCL-TypeD RS of the same TCI state/QCL assumption of the CORESET with the lowest ID.

In some example embodiments, a unified TCI framework may be exploited, the unified TCI framework meaning that TCI states so far providing QCL assumptions for the reception of DL signals and channels would be used also to provide spatial sources for the transmission of UL signals and channels.

In some example embodiments, governmental Maximum Permissible Exposure, MPE, guidelines may be in place to prevent health issues due to thermal effect. The MPE may be for example a regulation on a power density related to a signal transmitted by an antenna of UE 110. For instance, in the millimetre-wave regime a threshold for the MPE set by the Federal Communications Commission, FCC, may be 10 W/m² (1 mW/cm²). Also, for a certain distance separating a tissue of a human from the antenna, a power back-off may be required, for example for FCC compliance with the MPE. The required power back-off may be rather large though, e.g., up to 30 dB for wireless devices transmitting at a maximum effective isotropic radiated power limit, such as 43 dBm for PC3 UEs. Thus, the required back-off will likely cause radio link failures, since a large back-off would degrade an UL such that a maximum number of radio link control retransmissions would be reached. Moreover, the power back-off may only apply to the UL and thus result in severe link imbalance between UL and DL budgets.

It should be noted that during MPE events, a body of a user of UE 110 may severely block a propagation path between UE 110 and wireless network node 120 as well. As such, path losses in both, UL and DL, may be affected (almost) equally by the blockage caused by an MPE event, but UL transmit power would be further reduced due to transmission power restriction caused by the MPE. Even though degradation of the UL conditions may affect signal-to-noise ratio in UL only, but not in DL, a blockage caused by the user of UE 110 may lead to a beam failure and/or radio link failure.

If an MPE event is detected at UE 110, UE 110 may apply Power Management-Maximum Power Reduction, P-MPR, and transmit Power Headroom Report, PHR, possibly including P-MPR information, on the serving link to wireless network node 120. At least in cellular communication networks, it would be beneficial to identify and specify features to facilitate UL beam selection for UE 110 equipped with multiple panels, consider UL coverage loss mitigation due to MPE, based on UL beam indication with the unified TCI framework for UL fast panel selection.

In connected mode, the selection of the UL transmit beam of UE 110 may be performed by wireless network node 120 by explicitly providing the spatial source per UL signal and channel. Example embodiments of the present invention facilitate selection of the UL transmit beam by UE 110 while making it possible for UE 110 and wireless network node 120 to still remain beam aligned after a switch of an UL beam of UE 110. In addition, wireless network node 120 may be in control of the operation.

MPE is one example of a use case where UL beam switch initiated by UE 110 is very beneficial. If a user is nearly touching the antenna of UE 110, the maximum allowed Effective Isotropic Radiated Power, EIRP, for MPE compliance may be so low, e.g. only 10 dBm, that the power may have to suddenly and unpredictably be backed-off by up to 24 dB for 100% UL duty cycle. The power back-off of UE 110 may throttle transmit power of UE 110 which is in power limitation or close to it, e.g. cell edge UEs, Non-Line-of-Sight, NLOS, scenarios, etc. Therefore, the power received by wireless network node 120 may be reduced and consequently, the UL Signal-to-Interference-plus-Noise Ratio, SINR, as well. Hence, MPE mechanism may potentially cause UL failures and degradation of UL conditions, such as received power at wireless network node 120.

Even though the user blockage may affect both UL and DL, MPE may have more impact on UL than DL. Furthermore, at least on millimeter waves, the user effects may be mostly reflective, as opposed to mostly absorptive in FR1. Thus, the user blockage may be insignificant in DL. As such, wireless network node 120 may be unaware of the user presence on configured/active DL TCI states.

If an MPE event is reported on the current UL beam of UE 110, wireless network node 120 may be blind about which TCI state to switch to, as DL RS reporting may not necessarily indicate the best beam for UL. Example embodiments of the present invention therefore target UL beam management enhancements, specifically UL beam selection initiated by UE 110, and joint selection of UL and DL beams.

According to example embodiments of the present invention, wireless network node 120 may provide to UE 110 association information between a set of activated TCI states and a set of UL indication signals, wherein at least one activated TCI state of the set of activated TCI states may be associated with at least one UL indication signal of the set of UL indication signals. In some example embodiments, each UL indication signal of the set of UL indication signals may be used to indicate a separate activated TCI state of the set of activated TCI states. One UL indication signal may indicate one activated TCI state preferred and selected by UE 110. Thus, UE 110 may indicate one preferred activated TCI state by transmitting the corresponding UL indication signal to wireless network node. However, each activated TCI state may, or may not, have an associated UL indication signal. That is, only some of the set of activated TCI states may be associated with an UL indication signal.

After using a first activated TCI state of the set of TCI states to communicate with wireless network node 120, UE 110 may select a second TCI state from the set of activated TCI states and transmit one UL indication signal of the set of UL indication signals to wireless network node 120, wherein said one UL indication signal may indicate the second activated TCI state of the set of activated TCI states. UE 110 may select the second TCI state for communication from the activated TCI states that have associated UL indication signals. UE 110 may be in connected mode with wireless network node 120, as activated TCI states may be provided and used in connected mode.

In some example embodiments, the UL indication signals may be Contention-Free Random Access, CFRA, preambles. Alternatively, the UL indication signals may be SRSs. In some embodiments, the UL indication signals may be associated with CSI reporting on PUCCH and/or PUSCH, where CSI reporting may comprise the UL indication indicating the preferred TCI state, i.e., the preferred beam (preferred DL RS). Thus, example embodiments of the present invention are not restricted to any particular UL indication signals.

In some example embodiments, the activated TCI states may be UL TCI states. Alternatively, the activated TCI states may be joint DL and UL TCI states. Thus, example embodiments of the present invention are not restricted to any particular TCI states, but the activated TCI states may be associated with UL and possibly affected by an MPE event.

In some example embodiments, UE 110 may transmit said one UL indication signal prior to communicating with wireless network node 120 using the second activated TCI state of the set of activated TCI states. For instance, prior to the use of another activated TCI state than the current ones applicable for communicating, e.g., for the UL transmission, like PUCCH or PUSCH, UE 110 may transmit a CFRA preamble associated with the selected, second UL TCI state of the set of TCI states currently activated.

In some example embodiments, communicating may refer to transmitting and/or receiving. UE 110 may for example transmit the UL signal with the same spatial domain transmission filter used for the reception of the RS of the TCI state. Alternatively, or in addition, UE 110 may use the same spatial domain transmission filter for the reception of the DL signal that it used for the reception of the RS of the TCI state.

Wireless network node 120 may, or may not, transmit an acknowledgement responsive to receiving said one UL indication signal, wherein said one UL indication signal indicates the second activated TCI state of the set of activated TCI states. For instance, it may be configured or specified in 3GPP standard specifications whether wireless network node 120 transmits the acknowledgement. The acknowledgement may be a dedicated DCI format on PDCCH or some other DCI format. Thus, in some examples, UE 110 may start to communicate using the second activated TCI state without the need to wait for confirmation or acknowledgement from the network. In some other examples, UE 110 may need to wait for confirmation or acknowledgement from the network before starting to communicate using the second activated TCI state.

For instance, wireless network node 120 may transmit an acknowledgement to UE 110, wherein the acknowledgement indicates that the second activated TCI state of the set of activated TCI states is to be used. That is, wireless network node 120 may confirm, responsive to receiving said one UL indication signal indicating the second activated TCI state, that the second activated TCI state selected by UE 110 is to be used for communicating between UE 110 and wireless network node 120. UE 110 and wireless network node 120 may communicate using the second activated TCI state of the set of TCI states once UE 110 has received the acknowledgement.

Alternatively, wireless network node 120 may transmit an acknowledgement to UE 110, wherein the acknowledgement indicates that a third activated TCI state of the set of activated TCI states is to be used. For instance, acknowledgement signaling on DCI may be used by wireless network node 120 to indicate the TCI state to be used, such as the third TCI state, among the set of activated TCI states of UE 110. UE 110 and wireless network node 120 may communicate using the third activated TCI state of the set of TCI states once UE 110 has received the acknowledgement.

Alternatively, wireless network node 120 may transmit an acknowledgement to UE 110, wherein the acknowledgement is a negative acknowledgement. Upon receiving the negative acknowledgement, a fall-back/default TCI state, or spatial relation RS, may be assumed to be used and UE 110 may for example form an UL transmit beam based on the fall-back TCI state. UE 110 and wireless network node 120 may communicate using the fall-back TCI state once UE 110 has received the negative acknowledgement. The fall-back TCI state may be a TCI state with a lowest ID among activated TCI states of UE 110. Alternatively, the fall-back TCI state may be a TCI state with a lowest ID among the activated TCI states that does not have an associated UL indication signal, such as CFRA resource/preamble. In some example embodiments, wireless network node 120 may confirm by transmitting an activation message which TCI state is to be used as the fall-back TCI state.

In some example embodiments, UE 110 may be configured to transmit multiple, i.e., at least two UL indication signals before receiving an acknowledgement from wireless network node 120. UE 110 may transmit said one UL indication signal indicating the second activated TCI state of the set of activated TCI states and at least one other UL indication signal of the set of UL indication signals to wireless network node 120. Hence, UE 110 may indicate feasibility of at least two activated TCI states to wireless network node 120 and wireless network node 120 may choose the indicated at least two activated TCI states the TCI state to be used.

Wireless network node 120 may then transmit an indication indicating an activated TCI state to be used, the activated TCI state to be used being the second activated TCI state corresponding to said one UL indication signal or an activated TCI state corresponding to the at least one other UL indication signal. That is, wireless network node 120 may acknowledge one of said one UL indication signal indicating the second activated TCI state of the set of activated TCI states and at least one other UL indication signal. After that, UE 110 and wireless network node 120 may communicate using the acknowledged, activated TCI state to be used.

UE 110 may transmit said one UL indication signal indicating the second activated TCI state of the set of activated TCI states and at least one other UL indication signal sequentially or simultaneously depending on capabilities of UE 110, e.g., depending on whether there is a single transmit chain or multiple transmit chains in the transceiver of UE 110.

In some example embodiments, there may be a preamble transmission time window within which said one UL indication signal indicating the second activated TCI state of the set of activated TCI states and the at least one other UL indication signal are to be sent and possibly for which the acknowledgement of wireless network node 120 is valid. That is, UE 110 may transmit said one UL indication signal and the at least one other UL indication signal within the preamble transmission time window for example.

In some example embodiments, there may be an acknowledgement time window during which UE 110 may assume the acknowledgement message to be transmitted by wireless network node 120. UE 110 may start an acknowledgement timer upon transmitting said one UL indication signal and communicating with wireless network node 120 using the fall-back TCI state if no acknowledgement is received while the acknowledgement timer was running. That is, UE 110 may decide to use the fall-back TCI state if no acknowledgement is received before expiry of the acknowledgement timer.

In some example embodiments, UE 110 may start communicating with wireless network node 120 using the second activated TCI state without waiting for any acknowledgement. For instance, if a receiver beam of wireless network node 120 covers at least two activated beams of UE 110, wireless network node 120 may give permission to UE 110 to start communicating with wireless network node 120 using the second activated TCI state without waiting for any acknowledgement, if the second activated TCI state corresponds to the least two activated beams of UE 110 covered by the receiver beam of wireless network node 120. In such a case, the receiver beam of wireless network node 120 may be wider than the at least two activated beams of UE 110.

There may be a time duration/period defined between a time instance of transmission of said one UL indication signal and use of the second TCI selected by UE 110. That is, UE 110 may start a beam switch delay timer upon transmitting said one UL indication signal and communicate with wireless network node 120 using the second activated TCI state upon expiry of the beam switch delay timer, without waiting for any acknowledgement from wireless network node 120. In such a case, UE 110 and wireless network node 120 may communicate using the first activated TCI state while the beam switch delay timer is running.

Alternatively, if an acknowledgement is provided by wireless network node 120, there may be a time duration between reception of the acknowledgement and the use of the second TCI state selected by UE 110. UE 110 may start a beam activation timer upon receiving the acknowledgement and communicate with wireless network node 120 using the second activated TCI state, the third activated TCI state or the fall-back TCI state upon expiry of the beam activation timer. The beam activation timer may give wireless network node 120 processing time, to prepare receive beam of wireless network node 120 for receiving UL transmission from UE 110. The used, first TCI state may be used until the beam activation timer expires.

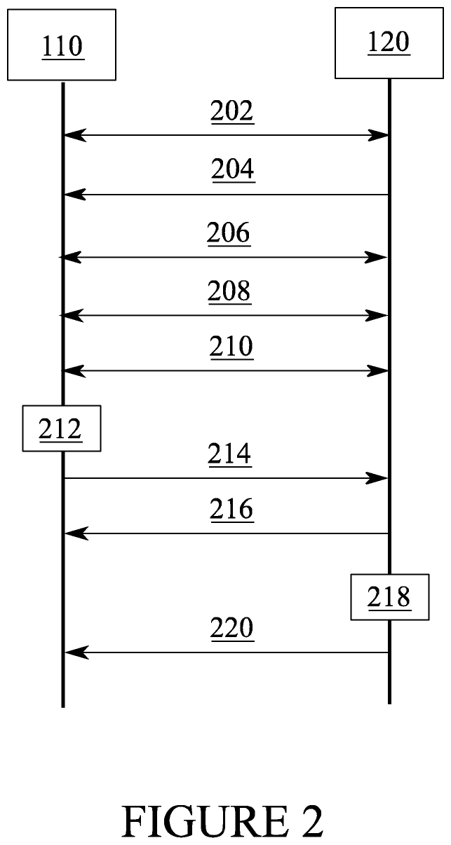

FIG. 2 illustrates a first signaling graph in accordance with at least some example embodiments. On the vertical axes are disposed, from the left to the right, UE 110 and wireless network node 120. Time advances from the top towards the bottom.

At step 202, a Radio Resource Control, RRC, connection may be established between UE 110 and wireless network node 120. UE 110 may thus be in connected mode during the following steps. After establishment of the RRC connection, wireless network node 120 may activate TCI states (e.g. 3 TCI states), each associated with a DL RS, such as DL RS1, DL RS2 and DL RS3. Each of the DL RSs may have its own CFRA configuration and its own preamble associated with the given CFRA configuration. That is, each of the DL RSs may be associated with a separate UL indication signal and each UL indication signal of the set of UL indication signals may indicate a separate activated TCI state of the set of activated TCI states.

Wireless network node 120 may, at step 204, transmit to UE 110 association information between a set of activated TCI states and a set of UL indication signals, wherein at least one activated TCI state of the set of activated TCI states may be associated with at least one UL indication signal of the set of UL indication signals. Said association information may be transmitted later on as well.

At step 206, UE 110 may be served by wireless network node 120 using TCI state 1, i.e., UE 110 may communicate with wireless network node 120 using the first activated TCI state. The first TCI state may be associated with DL RS1. At step 208, UE 110 may monitor DL RS2. At step 210, UE 110 may monitor DL RS3.

At step 212, UE 110 may detect a need to change from the used, first activated TCI state of the set of activated TCI states to the second activated TCI state of the set of activated TCI states. For instance, UE 110 may detect that UL conditions have been degraded, e.g., due to an MPE event. UE 110 may detect the need to change due to an MPE event, predicted MPE event, predicted blockage or UE rotation, or optimizing UE power consumption by reducing the number of active panels, etc.

If the current, first TCI state cannot support good enough UL quality, e.g. due to MPE, and wireless network node 120 has not indicated whether to resume UL on the second activated TCI state or the third activated TCI state, UE 110 may indicate the primary preferred UL beam by transmitting, at step 214, one UL indication signal of the set of UL indication signals to wireless network node 120, wherein said one UL indication signal indicates for example the second activated TCI state of the set of activated TCI states. UE 110 may for example transmit the preamble of the configured CFRA resource associated with DL RS2. Hence, a beam failure is not required and a beam switch may be initiated by UE 110. Then, wireless network node 120 is aware of the preferred UL beam of UE 110 and may choose to continue communicating with UE 110 using the preferred UL beam. Wireless network node 120 therefore remains in control of the activation of such beam and may choose another UL beam instead of the preferred one.

At step 216, wireless network node 120 may transmit an acknowledgement to UE 110, the acknowledgement indicating that the second activated TCI state of the set activated TCI states is to be used. The acknowledgement may be a DCI acknowledgement. In some example embodiments, the acknowledgement may comprise, or be transmitted along with, a timer value for a beam activation timer. UE 110 and wireless network node 120 may start the beam activation timer upon receiving and transmitting the timer value, respectively.

At step 218, wireless network node 120 may activate the second activated TCI state of the set activated TCI states for UL of UE 110 while the beam activation timer is running. Upon expiry of the beam activation timer, wireless network node 120 may transmit an activation command to UE 110. The activation command may be a DCI activation for example. UE 110 and wireless network node 120 may then communicate using the second activated TCI state.

In some example embodiments, there may be at least one activated TCI state that is not associated with any UL signal indication, such as a CFRA preamble. One of the at least one activated TCI state that is not associated with any UL signal indication may act as the fallback/default TCI state for the case when wireless network node 120 transmits a negative acknowledgment in response to receiving said one UL signal indication from UE 110. That is, wireless network node 120 may transmit the negative acknowledgement for the CFRA transmission(s) of UE 110 and in such a case UE 110 and wireless network node 120 may continue communicate using the fall-back TCI state.

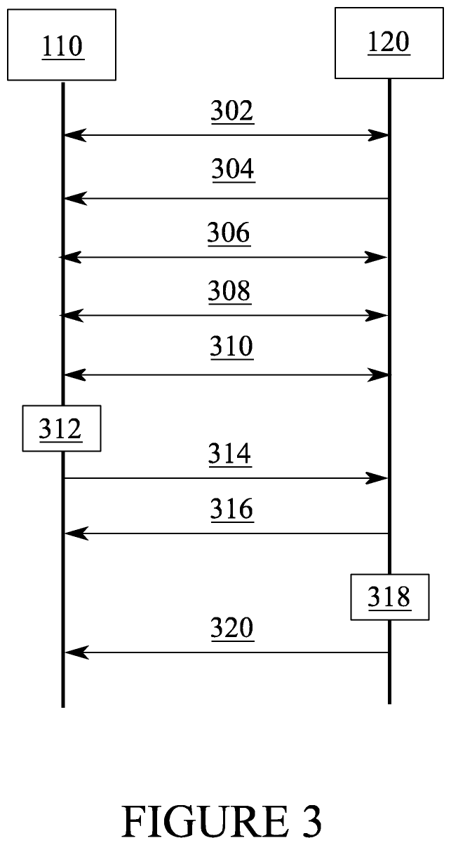

FIG. 3 illustrates a second signaling graph in accordance with at least some example embodiments. On the vertical axes are disposed, from the left to the right, UE 110 and wireless network node 120. Time advances from the top towards the bottom. Steps 302-312 shown in FIG. 3 may be the same as steps 202-212 shown in FIG. 2.

At step 314, UE 110 may transmit also an UL signal indication of a secondary preference for UL beam. That is, UE 110 may, at step 314, transmit at least one other UL indication signal of the set of UL indication signals to wireless network node 120 in addition to said one UL signal indication. The at least one other UL indication signal may indicate a third activated TCI state of the set of activated TCI states. Wireless network node 120 may then choose whether to use the second, the third or fall-back activated TCI state indicated by UE 110.

Wireless network node 120 may decide to use the second, the third or the fall-back activated TCI state depending on the UL beam availability for example. Hence, if the primary indicated UL beam corresponding to the second activated TCI state is not used yet, UE 110 may be scheduled to use the second activated TCI state. However, if the primary UL beam is in use already, the secondary indicated UL beam corresponding to the third activated TCI may be scheduled for UE 110. The fall-back TCI state may be scheduled if the second and the third activated TCI states are not available.

In some example embodiments, UE 110 may transmit the at least one other UL indication signal of the set of UL indication signals to wireless network node 120 in addition to said one UL signal indication sequentially to indicate ranking of the preferred UL beams. Ranking of selection of UE 110 may follow timing of the transmissions of the UL signal indications or may be indicated explicitly. Alternatively, UE 110 may transmit the at least one other UL indication signal of the set of UL indication signals to wireless network node 120 in addition to said one UL signal indication simultaneously if capabilities of UE 110 allows simultaneous transmissions, possibly including ranking indication. Wireless network node 120 may then choose the best UL beam available to activate, e.g. depending on load. At steps 316-320, wireless network node 120 may transmit the acknowledgement, activate the chosen TCI state and transmit an activation command in the same way as at steps 216-220 shown in FIG. 2, respectively.

Example embodiments of the present invention therefore enable UL beam selection initiated by UE 110 while wireless network node 120 remains in control as UE 110 may only choose among the set of active TCI states and the activation may still be done by wireless network node 120 for example with a DCI. If UE 110 has multiple preferred UL beams, wireless network node 120 may choose the best one to activate, e.g., depending on load.

The set of activated TCI states provided by wireless network node 120 may comprise TCI states that wireless network node 120 has selected and activated for UE 110, for a UE-initiated selection process. However, wireless network node 120 may anyway select one TCI state of the set of activated TCI states to be used with or without an indication of UE 110. In some embodiments, there may be additional TCI states and wireless network node 120 may select one of said additional TCI states with or without an indication of UE 110.

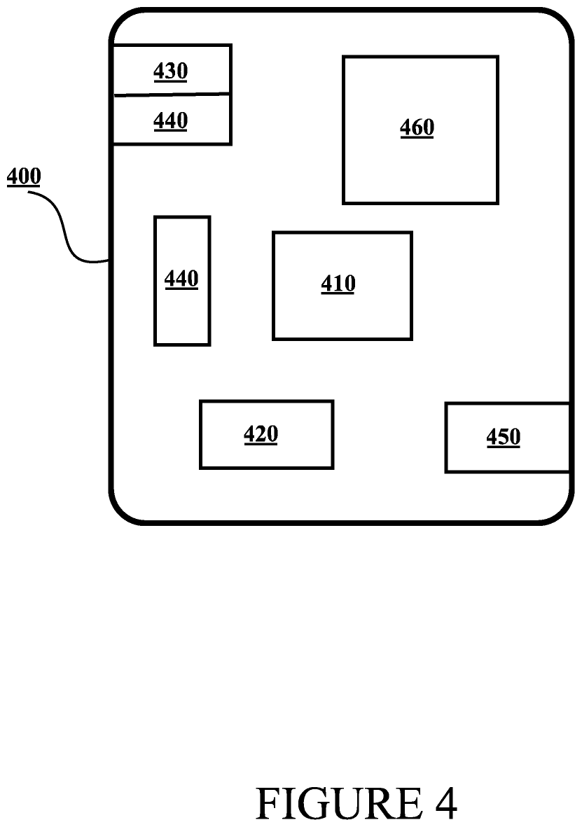

FIG. 4 illustrates an example apparatus capable of supporting at least some example embodiments. Illustrated is device 400, which may comprise, for example, UE 110 or wireless network node 120, or a control device configured to control the functioning thereof, possibly when installed therein. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. Processor 410 may be a control device. A processing core may comprise, for example, a Cortex-A8 processing core manufactured by ARM Holdings or a Steamroller processing core produced by Advanced Micro Devices Corporation. Processor 410 may comprise at least one Qualcomm Snapdragon and/or Intel Atom processor. Processor 410 may comprise at least one application-specific integrated circuit, ASIC. Processor 410 may comprise at least one field-programmable gate array, FPGA. Processor 410 may be means for performing method steps in device 400. Processor 410 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver. Transmitter 430 and/or receiver 440 may be configured to operate in accordance with Global System for Mobile communication, GSM, Wideband Code Division Multiple Access, WCDMA, Long Term Evolution, LTE, and/or 5G/NR standards, for example.

Device 400 may comprise a Near-Field Communication, NFC, transceiver 450. NFC transceiver 450 may support at least one NFC technology, such as Bluetooth, Wibree or similar technologies.

Device 400 may comprise User Interface, UI, 460. UI 460 may comprise at least one of a display, a keyboard, a touchscreen, a vibrator arranged to signal to a user by causing device 400 to vibrate, a speaker and a microphone. A user may be able to operate device 400 via UI 460, for example to accept incoming telephone calls, to originate telephone calls or video calls, to browse the Internet, to manage digital files stored in memory 420 or on a cloud accessible via transmitter 430 and receiver 440, or via NFC transceiver 450, and/or to play games.

Device 400 may comprise or be arranged to accept a user identity module 470. User identity module 470 may comprise, for example, a Subscriber Identity Module, SIM, card installable in device 400. A user identity module 470 may comprise information identifying a subscription of a user of device 400. A user identity module 470 may comprise cryptographic information usable to verify the identity of a user of device 400 and/or to facilitate encryption of communicated information and billing of the user of device 400 for communication effected via device 400.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. For example, where device 400 comprises a smartphone, it may comprise at least one digital camera. Some devices 400 may comprise a back-facing camera and a front-facing camera, wherein the back-facing camera may be intended for digital photography and the front-facing camera for video telephony. Device 400 may comprise a fingerprint sensor arranged to authenticate, at least in part, a user of device 400. In some example embodiments, device 400 lacks at least one device described above. For example, some devices 400 may lack a NFC transceiver 450 and/or user identity module 470.

Processor 410, memory 420, transmitter 430, receiver 440, NFC transceiver 450, UI 460 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the example embodiment various ways of interconnecting at least two of the aforementioned devices may be selected without departing from the scope of the example embodiments.

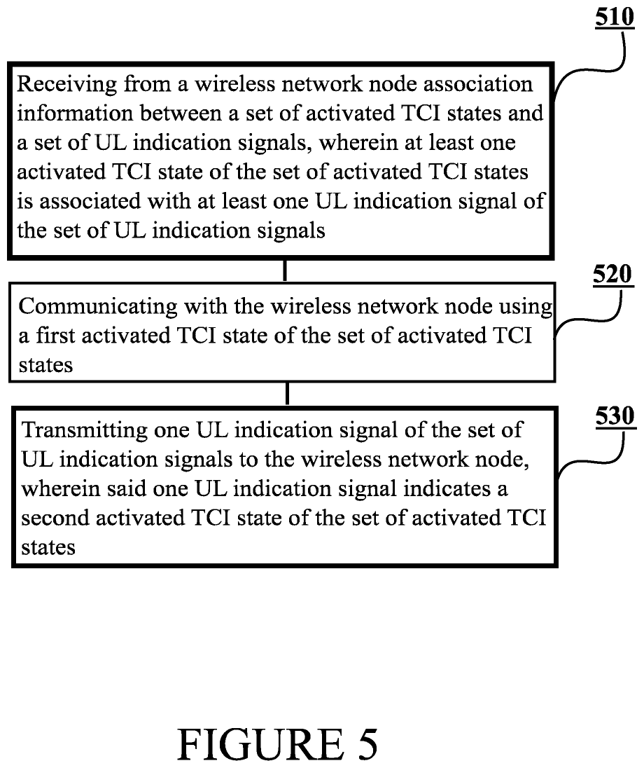

FIG. 5 is a flow graph of a first method in accordance with at least some example embodiments. The phases of the illustrated first method may be performed by UE 110 or by a control device configured to control the functioning thereof, possibly when installed therein.

The first method may comprise, at step 510, receiving from a wireless network node association information between a set of activated Transmission Coordination Indication, TCI, states and a set of Uplink, UL, indication signals, wherein at least one activated TCI state of the set of activated TCI states is associated with at least one UL indication signal of the set of UL indication signals. The first method may further comprise, at step 520, communicating with the wireless network node using a first activated TCI state of the set of activated TCI states. Finally, the first method may comprise, at step 530, transmitting one UL indication signal of the set of UL indication signals to the wireless network node, wherein said one UL indication signal indicates a second activated TCI state of the set of activated TCI states.

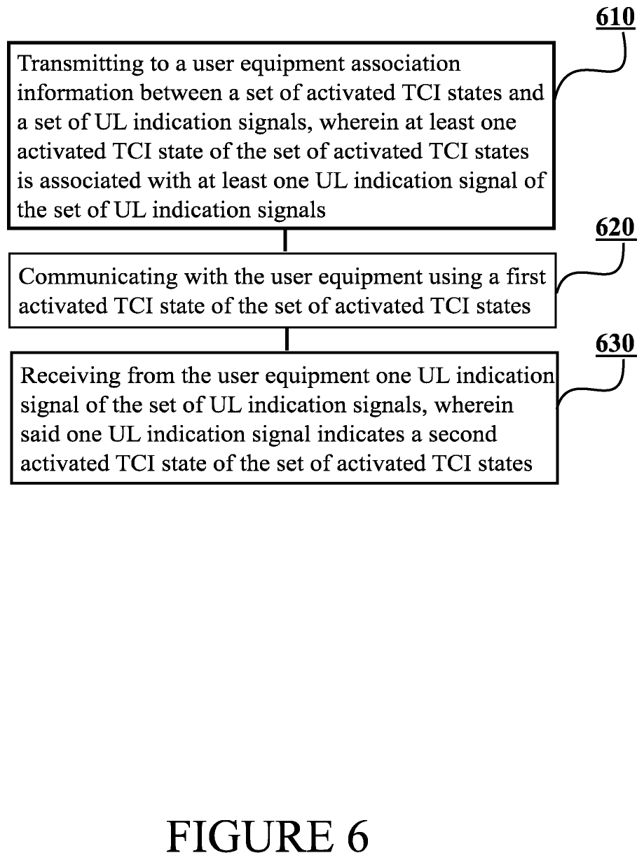

FIG. 6 is a flow graph of a second method in accordance with at least some example embodiments. The phases of the illustrated second method may be performed by wireless network node 120 or by a control device configured to control the functioning thereof, possibly when installed therein.

The second method may comprise, at step 610, transmitting to a user equipment association information between a set of activated Transmission Coordination Indication, TCI, states and a set of UL indication signals, wherein at least one activated TCI state of the set of activated TCI states is associated with at least one Uplink, UL, indication signal of the set of UL indication signals. The second method may also comprise, at step 620, communicating with the user equipment using a first activated TCI state of the set of activated TCI states. Finally, the second method may comprise, at step 630, receiving from the user equipment one UL indication signal of the set of UL indication signals, wherein said one UL indication signal indicates a second activated TCI state of the set of activated TCI states.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, such as, for example, UE 110 or wireless network node 120, may comprise means for carrying out the example embodiments described above and any combination thereof.

In an example embodiment, a computer program may be configured to cause a method in accordance with the example embodiments described above and any combination thereof. In an example embodiment, a computer program product, embodied on a non-transitory computer readable medium, may be configured to control a processor to perform a process comprising the example embodiments described above and any combination thereof.

In an example embodiment, an apparatus, such as, for example, UE 110 or wireless network node 120, may comprise at least one processor, and at least one memory including computer program code, wherein the at least one memory and the computer program code are configured to, with the at least one processor, cause the apparatus at least to perform the example embodiments described above and any combination thereof.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the example embodiments in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some example embodiments find industrial application in cellular communication networks, for example in 3GPP networks, wherein beamforming is used.

### ACRONYMS LIST

3GPP 3rd Generation Partnership Project
BS Base Station
BWP Bandwidth Part
CC Component Carrier
CFRA Contention-Free Random Access
CORESET Control Resource Set
CSI-RS Channel State Information-Reference Signal
DCI Downlink Control Information
DL Downlink
DU Distributed Unit
EIRP Effective Isotropic Radiated Power
FCC Federal Communications Commission
FR Frequency Range
GSM Global System for Mobile communication
IAB Integrated Access and Backhaul
ID Identity
IoT Internet of Things
LTE Long-Term Evolution
M2M Machine-to-Machine
MPE Maximum Permissible Exposure
MT Mobile Terminal
NFC Near-Field Communication
NLOS Non-Line-of-Sight
NR New Radio
P-MPR Power management-Maximum Power Reduction
PDSCH Physical Downlink Shared Channel
PHR Power Headroom Report
PUCCH Physical UL Control Channel
PUSCH Physical UL Shared Channel
QCL Quasi Co-Location
RAN Radio Access Network
RAT Radio Access Technology
RRC Radio Resource Control
RS Reference Signal
RSRP Reference Signal Receive Power
SINR Signal-to-Interference-plus-Noise Ratio
SRS Sounding Reference Signal
SSB Synchronization Signal Block
TRP Transmission and Reception Point
UE User Equipment
UI User Interface
UL UL
WCDMA Wideband Code Division Multiple Access
WiMAX Worldwide Interoperability for Microwave Access
WLAN Wireless Local Area Network

### REFERENCE SIGNS LIST

| | |
|---|---|
| 110 | UE |
| 112, 114 | Beams |
| 120 | Wireless network node |
| 125, 135 | Wired interfaces |
| 130 | Core Network |
| 202-220 | Steps in the signaling graph of FIG. 2 |
| 302-320 | Steps in the signaling graph of FIG. 3 |
| 400-470 | Structure of the apparatus of FIG. 4 |
| 510-530 | Phases of the first method in FIG. 5 |
| 610-630 | Phases of the second method in FIG. 6 |

1. An apparatus, comprising at least one processor, and at least one memory including computer program code, wherein the at least one memory and the computer program code are configured to, with the at least one processor, cause the apparatus at least to perform:
receive from a wireless network node association information between a set of activated Transmission Coordination Indication, TCI, states and a set of Uplink, UL, indication signals, wherein at least one activated TCI state of the set of activated TCI states is associated with at least one UL indication signal of the set of UL indication signals;
communicate with the wireless network node using a first activated TCI state of the set of activated TCI states; and
transmit one UL indication signal of the set of UL indication signals to the wireless network node, wherein said one UL indication signal indicates a second activated TCI state of the set of activated TCI states.

2. The apparatus according to claim 1, wherein each UL indication signal of the set of UL indication signals indicates a separate activated TCI state of the set of activated TCI states.

3. The apparatus according to claim 1, further caused to perform:
detect a need to change from the used, first activated TCI state of the set of activated TCI states to the second activated TCI state of the set of activated TCI states.

4. The apparatus according to claim 1, further caused to perform:
receive an acknowledgement from the wireless network node, wherein the acknowledgement indicates that the second activated TCI state of the set activated TCI states is to be used; and
communicate with the wireless network node using the second activated TCI state of the set of activated TCI states upon receiving the acknowledgement.

5. The apparatus according to claim 1, further caused to perform:
receive an acknowledgement from the wireless network node, wherein the acknowledgement indicates that a third activated TCI state of the set of activated TCI states is to be used; and
communicate with the wireless network node using the third activated TCI state of the set of activated TCI states upon receiving the acknowledgement.

6. The apparatus according to claim 1, further caused to perform:
receive an acknowledgement from the wireless network node, wherein the acknowledgement is a negative acknowledgement; and
communicate with the wireless network node using a fall-back TCI state upon receiving the negative acknowledgement.

7. The apparatus according to claim 1, further caused to perform:
start a beam activation timer upon receiving an acknowledgement from the wireless network node; and
communicate with the wireless network node using the second activated TCI state, a third activated TCI state or a fall-back TCI state upon expiry of the beam activation timer.

8. The apparatus according to claim 1, further caused to perform:
start an acknowledgement timer upon transmitting said one UL indication signal; and
communicate with the wireless network node using a fall-back TCI state when no acknowledgement was received while the acknowledgement timer was running.

9. The apparatus according to claim 1, further caused to perform:
communicate with the wireless network node using the second activated TCI state without waiting for any acknowledgement.

10. The apparatus according to claim 9, further caused to perform:
start a beam switch delay timer upon transmitting said one UL indication signal; and
communicate with the wireless network node using the second activated TCI state upon expiry of the beam switch delay timer.

11. The apparatus according to claim 1, further caused to perform:
transmit at least one other UL indication signal of the set of UL indication signals to the wireless network node;
receive an indication from the wireless network node, wherein the indication indicates an activated TCI state to be used, the activated TCI state to be used being the second activated TCI state corresponding to said one UL indication signal or an activated TCI state corresponding to the at least one other UL indication signal; and
communicate with the wireless network node using the activated TCI state to be used.

12. The apparatus according to claim 11, wherein said one UL indication signal and the at least one other UL indication signal are transmitted within a preamble transmission time window.

13. An apparatus comprising at least one processor, and at least one memory including computer program code, wherein the at least one memory and the computer program code are configured to, with the at least one processor, cause the apparatus at least to perform:
transmit to a user equipment association information between a set of activated Transmission Coordination Indication, TCI, states and a set of UL indication signals, wherein at least one activated TCI state of the set of activated TCI states is associated with at least one Uplink, UL, indication signal of the set of UL indication signals;
communicate with the user equipment using a first activated TCI state of the set of activated TCI states; and
receive from the user equipment one UL indication signal of the set of UL indication signals, wherein said one UL indication signal indicates a second activated TCI state of the set of activated TCI states.

14. A method, comprising:
receiving from a wireless network node association information between a set of activated Transmission Coordination Indication, TCI, states and a set of Uplink, UL, indication signals, wherein at least one activated TCI state of the set of activated TCI states is associated with at least one UL indication signal of the set of UL indication signals;
communicating with the wireless network node using a first activated TCI state of the set of activated TCI states; and
transmitting one UL indication signal of the set of UL indication signals to the wireless network node, wherein said one UL indication signal indicates a second activated TCI state of the set of activated TCI states.

15. (canceled)
